(19) United States
(12) Patent Application Publication
(10) Pub. No.: US 2024/0278175 A1
(43) Pub. Date: Aug. 22, 2024

(54) METHOD FOR RECYCLING AMMONIA FROM AMMONIA-CONTAINING GAS OR AMMONIA-CONTAINING LIQUID, AMMONIA RECYCLING DEVICE, AND AMMONIA GAS STORAGE DEVICE

(71) Applicants: Daiseki Co., Ltd., Aichi (JP); SyncMOF Inc., Aichi (JP)

(72) Inventors: Tetsuya YAMAMOTO, Aichi (JP); Kenichiro YAGI, Aichi (JP); Kazuya NISHITA, Aichi (JP); Naoto MIWA, Aichi (JP); Junichi HATAOKA, Aichi (JP); Akihiro HORI, Aichi (JP); Mai KOYAMA, Aichi (JP)

(73) Assignees: Daiseki Co., Ltd., Aichi (JP); SyncMOF Inc., Aichi (JP)

(21) Appl. No.: 18/568,884

(22) PCT Filed: Jun. 24, 2022
(86) PCT No.: PCT/JP2022/025317

§ 371 Date: Dec. 11, 2023

(30) Foreign Application Priority Data
Jun. 25, 2021 (JP) 2021-105695

(51) Int. Cl. B01D 53/58; B01D 53/82; B01D 53/96; B01J 20/22; B01J 20/28; C01C 1/10; C01C 1/12; F17C 11/00

(52) U.S. Cl. CPC B01D 53/58; B01D 53/82; B01D 53/96; B01J 20/226; B01J 20/2808; B01J 20/28083; B01J 20/28085; C01C 1/10; C01C 1/12; F17C 11/00; B01D 2253/204; B01D 2257/406

(57) ABSTRACT

An ammonia-containing liquid or an ammonia-containing gas is made to contact a porous coordination polymer in which a metal ion and an organic ligand coordinately bonded, ammonia is adsorbed to the porous coordination polymer, and the ammonia is desorbed from the ammonia-adsorbed porous coordination polymer to recover the ammonia. The porous coordination polymer that contacts the ammonia-containing liquid preferably has a water-soluble solvent adhered thereto. The ammonia-containing gas is preferably adjusted such that water is contained at an amount of 106 parts by mass or more when the ammonia content is 100 parts by mass.

### TECHNICAL FIELD

The present invention relates to a method for recycling ammonia in which ammonia is recovered from an ammonia-containing gas or an ammonia-containing liquid for reuse, an ammonia recycling apparatus, and an ammonia gas storage apparatus. In the present specification, “ammonia” means ammonia and an ammonium ion unless otherwise specified.

### BACKGROUND ART

Ammonia is widely used as a raw material for producing a cleaning agent to clean a surface at a time of producing a semiconductor, glass for a flat panel display and a hard disk, or a silicon substrate, a raw material for producing a nitride film or the like in a semiconductor, a raw material for producing an organic compound, a raw material for producing silver powder contained in silver paste used for forming a conductive portion such as an electrode or wiring, a refrigerant, or the like. As industries related to ammonia, there are industries that produce ammonia as well as industries that generate ammonia, such as the livestock industry. However, ammonia is harmful to the human body and the environment, and thus measures have been taken in various industries to suppress release of a waste liquid containing ammonia and release of exhaust gas containing ammonia into the atmosphere. For example, there are known treatments such as an ammonia stripping method, a biological nitrification-denitrogenation method, a chlorine oxidation method, a catalytic decomposition method, a wet absorption method, and a dry adsorption method. In particular, ammonia gas is generally washed and removed by a scrubber (sulfuric acid scrubber) using dilute sulfuric acid, and discharged as a scrubber waste liquid containing ammonium sulfate. In the detoxification and recovery of ammonia by a sulfuric acid scrubber, ammonia cannot be absorbed at a certain concentration or more from a viewpoint of the solubility of ammonium sulfate, and thus frequent liquid addition and blowing are required to reduce the amount of waste liquid.

As a method for producing ammonia, Haber-Bosch process is known, but in recent years, a method for producing ammonia in the atmosphere in the presence of a novel catalyst has been studied. In such a case, it is assumed that ammonia gas is retained in the plant, and it is necessary to recover the ammonia gas from a viewpoint of yield or environmental measures at the producing site.

Activated carbon, zeolite, and the like are known as an adsorbent that adsorbs, occludes, and desorbs ammonia. In recent years, an ammonia adsorbent containing, as an active component, a metal cyano complex represented by the general formula AₓM[M′(CN)₆]_{y}·zH₂O (see Patent Literature 1), a porous coordination polymer (including a metal organic structure MOF, the same applies hereinafter) such as MIL-53 (aluminum terephthalate), NH₂-MIL-53, MIL-100, and MIL-101 (see Non Patent Literature 1), and the like are known.

### PRIOR ART LITERATURE

### Patent Literature

Patent Literature 1: WO 2015-186819

### Non-Patent Literature

Non Patent Literature 1: Yang Chen, et al., Microporous and Mesoporous Materials 258 (2018) 170-177

### SUMMARY OF THE INVENTION

### Technical Problems

In a case of ammonia adsorption using a zeolite, since it is required to desorb ammonia from the zeolite and bring the zeolite into contact with a saline solution, a potassium chloride aqueous solution, or the like for zeolite reusing, the waste liquid treatment may not be easy. In a case of prussian blue, which is a representative example of the above metal cyano complex, large and small holes are irregularly formed by generating defects to form ammonia adsorption sites, but the size and number of defects cannot be controlled, thus causing a problem of unstable recover of ammonia.

An object of the present invention is to provide a method for recycling ammonia in which ammonia is recovered from an ammonia-containing gas or an ammonia-containing liquid for reuse, an ammonia recycling apparatus, and an ammonia gas storage apparatus in order to recycle ammonia released to the global environment and ammonia in a producing process or a discharge process as much as possible.

### Solutions to Problems

The present invention is as follows.

(1) A method for recycling ammonia from an ammonia-containing gas, characterized by bringing a gas containing ammonia into contact with a porous coordination polymer in which a metal ion and an organic ligand coordinately bonded to adsorb the ammonia to the porous coordination polymer, and subsequently desorbing the ammonia from an ammonia-adsorbed porous coordination polymer to recover the ammonia, the ammonia-adsorbed porous coordination polymer being formed by adsorbing the ammonia to the porous coordination polymer.
(2) The method for recycling ammonia from an ammonia-containing gas according to (1) above, wherein the porous coordination polymer has an internal pore with a pore diameter of 0.26 nm or more at time of adsorption of the ammonia.
(3) The method for recycling ammonia from an ammonia-containing gas according to (1) or (2) above, wherein the porous coordination polymer has an active site.
(4) The method for recycling ammonia from an ammonia-containing gas according to any one of (1) to (3) above, wherein the metal ion constituting the porous coordination polymer comprises a metal selected from a group consisting of Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, and Bi.
(5) The method for recycling ammonia from an ammonia-containing gas according to any one of (1) to (4) above, wherein the organic ligand constituting the porous coordination polymer is derived from carboxylic acids or azoles.
(6) The method for recycling ammonia from an ammonia-containing gas according to any one of (1) to (5) above, wherein the ammonia-containing gas is derived from a gas generated at a semiconductor manufacturing plant, an ammonia manufacturing plant, a chemical material manufacturing plant using ammonia, a chemical material manufacturing plant in which ammonia is by-produced, or a barn.
(7) The method for recycling ammonia from an ammonia-containing gas according to any one of (1) to (6) above, wherein the ammonia-containing gas is adjusted to contain 106 parts by mass or more of water when a content of the ammonia is set to 100 parts by mass.
(8) The method for recycling ammonia from an ammonia-containing gas according to any one of (1) to (7) above, wherein the porous coordination polymer is reused after the ammonia is desorbed from the ammonia-adsorbed porous coordination polymer.
(9) An ammonia recycling apparatus used for the method for recycling ammonia from an ammonia-containing gas according to any one of (1) to (8) above, characterized by comprising:
an ammonia-containing gas storage unit configured to store a gas containing ammonia;
an ammonia adsorption unit configured to store a porous coordination polymer and bring the exhaust gas supplied from the ammonia-containing gas storage unit into contact with the porous coordination polymer to adsorb the ammonia in the ammonia-containing gas to the porous coordination polymer.
an ammonia desorption unit configured to desorb the ammonia from the porous coordination polymer to which the ammonia is adsorbed, obtained in the ammonia adsorption unit; and
an ammonia recovery unit configured to recover the ammonia.
   (10) The ammonia recycling apparatus from an ammonia-containing gas according to (9) above, further comprising a water content adjusting unit configured to adjust a content ratio of water contained in the ammonia-containing gas so as to fall within a predetermined range based on a content of the ammonia, wherein the ammonia-containing gas contained in the ammonia-containing gas storage unit is derived from a gas generated at a semiconductor manufacturing plant, an ammonia manufacturing plant, a chemical material manufacturing plant using ammonia, a chemical material manufacturing plant in which ammonia is by-produced, or a barn.
   (11) A method for recycling ammonia from an ammonia-containing liquid, characterized by bringing an ammonia-containing liquid containing ammonia into contact with a porous coordination polymer in which a metal ion and an organic ligand coordinately bonded to adsorb the ammonia to the porous coordination polymer, and subsequently desorbing the ammonia from an ammonia-adsorbed porous coordination polymer to recover the ammonia, the ammonia-adsorbed porous coordination polymer being formed by adsorbing the ammonia to the porous coordination polymer.
   (12) The method for recycling ammonia from an ammonia-containing liquid according to (11) above, wherein a water-soluble organic solvent is adhered to the porous coordination polymer.
   (13) The method for recycling ammonia from an ammonia-containing liquid according to (11) or (12) above, wherein the porous coordination polymer has an active site.
   (14) The method for recycling ammonia from an ammonia-containing liquid according to any one of (11) to (13) above, wherein the metal ion constituting the porous coordination polymer comprises a metal selected from a group consisting of Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, and Bi.
   (15) The method for recycling ammonia from an ammonia-containing liquid according to any one of (11) to (14) above, wherein the organic ligand constituting the porous coordination polymer is derived from carboxylic acids or azoles.
   (16) The method for recycling ammonia from an ammonia-containing liquid according to any one of (11) to (15) above, wherein the ammonia-containing liquid is adjusted to be alkaline.
   (17) The method for recycling ammonia from an ammonia-containing liquid according to (16) above, wherein the ammonia contained in the alkaline ammonia-containing liquid is adsorbed to the porous coordination polymer, an acid is added to the remaining ammonia-containing liquid to form an acidic liquid, the ammonia-adsorbed porous coordination polymer is recovered, and then the ammonia is desorbed from the ammonia-adsorbed porous coordination polymer.
   (18) The method for recycling ammonia from an ammonia-containing liquid according to any one of (11) to (17) above, wherein the ammonia-containing liquid comprises a water-soluble organic solvent.
   (19) The method for recycling ammonia from an ammonia-containing liquid according to any one of (11) to (18) above, wherein the ammonia-containing liquid is derived from a liquid generated at a semiconductor manufacturing plant, an ammonia manufacturing plant, a chemical material manufacturing plant using ammonia, or a chemical material manufacturing plant in which ammonia is by-produced, or a liquid containing ammonia discharged from a living organism.
   (20) The method for recycling ammonia from an ammonia-containing liquid according to any one of (11) to (19) above, wherein the ammonia-containing liquid is a liquid subjected to ammonia stripping.
   (21) The method for recycling ammonia from an ammonia-containing liquid according to any one of (11) to (20) above, wherein the porous coordination polymer is reused after the ammonia is desorbed from the ammonia-adsorbed porous coordination polymer.
   (22) An ammonia recycling apparatus used for the method for recycling ammonia from an ammonia-containing liquid according to any one of (11) to (21) above, characterized by comprising:
an ammonia-containing liquid storage unit configured to store an ammonia-containing liquid containing ammonia;
an ammonia adsorption unit configured to store a porous coordination polymer and bring the ammonia-containing liquid supplied from the ammonia-containing liquid storage unit into contact with the porous coordination polymer to adsorb the ammonia in the ammonia-containing liquid to the porous coordination polymer.
an ammonia desorption unit configured to desorb the ammonia from the porous coordination polymer to which the ammonia is adsorbed, obtained in the ammonia adsorption unit; and
an ammonia recovery unit configured to recover the ammonia.
   (23) An ammonia gas storage apparatus characterized in that the apparatus comprises:
an ammonia gas storage unit comprising a porous coordination polymer in which a metal ion and an organic ligand coordinately bonded, wherein an ammonia gas supplied from an outside is adsorbed to the porous coordination polymer and is held in an adsorbed state; and
a pressure control unit configured to adjust a pressure in the ammonia gas storage unit,
and that the ammonia gas is stored by adjusting a supply amount of the ammonia gas to the ammonia gas storage unit and a pressure in the pressure control unit.

In the present specification, the pH of the liquid is a value at a temperature of 25° C.

### Effects of Invention

At a time of producing ammonia a large amount of energy is required and emission of carbon dioxide is accompanied which is said to be a main cause of global warming. The present invention can meet social demands for suppression of resource consumption and reduction in greenhouse gas emission.

According to the method for recycling ammonia from an ammonia-containing gas and the ammonia recycling apparatus of the present invention, ammonia can be efficiently recycled without directly releasing, to the atmosphere, the ammonia-containing gas generated at, for example, a semiconductor manufacturing plant, an ammonia manufacturing plant, a chemical material manufacturing plant using ammonia, a chemical material manufacturing plant in which ammonia is by-produced, or a barn. When ammonia is recovered, ammonia can be desorbed by a simple method such as exposing the ammonia-adsorbed porous coordination polymer to a reduced pressure atmosphere, which is economical. The porous coordination polymer after ammonia desorption can be reused, and thus it does not need to be discarded after use, which is economical.

According to the method for recycling ammonia from an ammonia-containing liquid and the ammonia recycling apparatus of the present invention, ammonia can be efficiently recycled without directly releasing, to a river or the like, a waste liquid generated at, for example, a semiconductor manufacturing plant, an ammonia manufacturing plant, a chemical material manufacturing plant using ammonia, or a chemical material manufacturing plant in which ammonia is by-produced, or a liquid containing ammonia discharged from a living organism. When ammonia is recovered, ammonia can be desorbed by a simple method such as exposing the ammonia-adsorbed porous coordination polymer to a reduced pressure atmosphere, which is economical. The porous coordination polymer after ammonia desorption can be reused, and thus it does not need to be discarded after use, which is economical.

According to the ammonia gas storage apparatus of the present invention, adsorption to the porous coordination polymer and desorption from the porous coordination polymer are easy without causing denaturation of ammonia, and the ammonia gas storage apparatus is suitable as a storage apparatus for an industrial raw material.

### BRIEF DESCRIPTION OF DRAWINGS

FIG. 1 is a schematic view showing an example of a configuration of an ammonia recycling apparatus of the present invention.

FIG. 2 is a schematic view showing another example of a configuration of an ammonia recycling apparatus of the present invention.

FIG. 3 is a schematic view showing another example of a configuration of an ammonia recycling apparatus of the present invention.

FIG. 4 is a schematic view showing an example of a configuration of an ammonia gas storage apparatus of the present invention.

FIG. 5 is a schematic view showing another example of a configuration of an ammonia gas storage apparatus of the present invention.

FIG. 6 is a schematic view of an ammonia gas adsorption test apparatus used in Experimental Examples 2-1 and 2-2.

### EMBODIMENT FOR CARRYING OUT THE INVENTION

The method for recycling ammonia of the present invention is a method for recovering ammonia from a gas containing ammonia (hereinafter, referred to as “ammonia-containing gas”) or a liquid containing ammonia (ammonia and/or an ammonium ion) (hereinafter, referred to as “ammonia-containing liquid”) using a porous coordination polymer in which a metal ion and an organic ligand are coordinate-bonded.

The ammonia recycling apparatus of the present invention is an apparatus for recovering ammonia from an ammonia-containing gas or an ammonia-containing liquid using a porous coordination polymer.

### 1. Porous Coordination Polymer

The porous coordination polymer is a component that traps ammonia molecules or an ammonium ion into the internal pore. In the present invention, a compound in which a metal ion and an organic ligand coordinately bonded is used. The porous coordination polymer chemically or physically adsorbs ammonia or an ammonium ion depending on its type.

Examples of the metal ion constituting the porous coordination polymer include each ion of Mg, Ca, Sr, Ba, Sc. Y, Ti, Zr, Hf, V, Nb, Ta, Cr, Mo, W, Mn, Re, Fe, Ru, Os, Co, Rh, Ir, Ni, Pd. Pt, Cu, Ag, Au, Zn, Cd, Hg, Al, Ga, In, Tl, Si, Ge, Sn, Pb, As, Sb, Bi, and the like. The metal ion may be contained singly or in combination of two or more types thereof in the porous coordination polymer.

The organic ligand constituting the porous coordination polymer may be derived from an aromatic compound, an aliphatic compound, an alicyclic compound, a heteroaromatic compound, a heterocyclic compound, or the like having a functional group capable of being coordinated to a metal ion. The organic ligand may be contained singly or in combination of two or more types thereof in the porous coordination polymer.

Examples of the functional group capable of coordinating to a metal ion include a carboxy group, a carboxylic anhydride group, a glycidyl group, —CH(OH)₂, —C(OH)₃, —CH(NH₂)₂, —C(NH₂)₃, —CH(CN)₂, —C(CN)₃, —CH(SH), —C(SH)₃, —CH(ROH)₂, —C(ROH)₃, —CH(RNH₂)₂, —C(RNH₂)₃, —CH(RCN)₂, —C(RCN)₃, —CH(RSH), —C(RSH)₃, —OH, —SH, —SO, —SO₂, —SO₃H, —NO₂, —NH₂, —NHR, —NR₂, —S—, —S—S—, —Si(OH)₃, —Ge(OH)₃, —Sn(OH)₃, —Si(SH)₃, —Ge(SH)₃, —Sn(SH)₃, —PO₃H, —AsO₃H, —AsO₃H, —PS₃H, —AsS₃H, and the like. R represents an aliphatic hydrocarbon group, an alicyclic hydrocarbon group, or an aromatic hydrocarbon group.

The functional group capable of coordinating to the metal ion may be a functional group derived from a nitrogen-containing compound such as pyridine, pyrimidine, pyridazine, pyrazine, triazine, triazole, tetrazole, imidazole, thiazole, oxazole, phenanthroline, quinoline, isoquinoline, naphthyridine, purine, bipyridine(4,4′-bipyridyl), or terpyridine.

In the present invention, the organic ligand is preferably a ligand derived from carboxylic acids or azoles.

In the present invention, the porous coordination polymer capable of efficiently adsorbing ammonia preferably has an active site that is a metal ion site to which ammonia as a guest molecule can be coordinated. The active site is a site that interacts with ammonia, and examples thereof include an open metal site and various functional groups. The number of active sites is not particularly limited, and may be one or two or more. Ammonia is more strongly adsorbed to the active site. When a porous coordination polymer having an active site is used, higher purity ammonia can be recovered utilizing a difference in the adsorbed state from other adsorption sites. The porous coordination polymer according to the present invention may be a compound having no active site as long as it can adsorb ammonia.

Depending on types of the metal ion and the organic ligand, the porous coordination polymer may contain a counter anion such as a chloride ion, a bromide ion, an iodide ion, a sulfate ion, a nitrate ion, a phosphate ion, a trifluoroacetate ion, a methanesulfonate ion, a toluenesulfonate ion, a benzenesulfonate ion, and a perchlorate ion in the present invention.

The shape and size of the porous coordination polymer are not particularly limited. The porous coordination polymer when used singly may be in form of particles, lumps, plates, or the like.

The porous coordination polymer may also be used as a composite in which the porous coordination polymer is supported on a surface of a support. The support in this case is preferably made of a material that does not react with ammonia.

The porous coordination polymer according to the present invention can be produced by a production method including a reaction step of reacting a metal compound (metal nitrates, metal sulfates, metal chlorides, hydrates thereof, and the like) that provides the above-mentioned metal ion with an organic compound that provides the above-mentioned organic ligand in a solvent. As the solvent, water, an amide (N,N-dimethylformamide, N,N-diethylformamide, and the like), an alcohol (methanol, ethanol, isopropyl alcohol, or the like), a carboxylic acid (formic acid, acetic acid, and the like), an ether, a ketone, or the like may be used. An acid or a base may be added to the reaction system as necessary.

In the reaction step, a compound that provides a metal ion and an organic compound that provides an organic ligand are preferably reacted. The reaction temperature is preferably in a range from 25° C. to 230° C.

Thereafter, the reaction product is washed and can be subjected to a purification step of purifying the porous coordination polymer. In this purification step, the above reaction solvent can be used as a washing solvent, and for example, the reaction product and the washing solvent are put in a container and stirred at a temperature ranging from preferably 0° C. to 230° C., and then filtration, and recovery and drying of a residue containing a porous coordination polymer may be performed.

In the method for recycling ammonia from an ammonia-containing liquid of the present invention, a porous coordination polymer to which a water-soluble organic solvent is adhered is preferably used, and a method for producing such a porous coordination polymer is described later.

2. Method for Recycling Ammonia from Ammonia-Containing Gas

The method for recycling ammonia from an ammonia-containing gas of the present invention is a method in which the ammonia-containing gas is brought into contact with the porous coordination polymer to adsorb ammonia to the porous coordination polymer, and then the ammonia is desorbed from an ammonia-adsorbed porous coordination polymer formed by adsorbing the ammonia to the porous coordination polymer to recover ammonia. That is, the method for recycling ammonia of the present invention includes a contact step of bringing the ammonia-containing gas into contact with the porous coordination polymer, a desorption step of desorbing ammonia from the ammonia-adsorbed porous coordination polymer, and an ammonia recovery step of recovering the desorbed ammonia.

First, in the method for recycling ammonia from an ammonia-containing gas, there are porous coordination polymers efficiently capable of adsorbing ammonia gas fluctuate in internal pores when the ammonia gas comes into contact with the porous coordination polymers, and therefore the porous coordination polymer is a material in which the pore diameter of the internal pores during adsorption of ammonia is preferably 0.26 nm or more, and more preferably in a range from 4 to 200 nm.

The metal ion constituting such a porous coordination polymer is preferably an ion of a metal selected from Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb, and Bi. The organic ligand is preferably a ligand derived from carboxylic acids or azoles, and examples thereof include: dicarboxylic acids such as succinic acid, tartaric acid, 1,4-butanedicarboxylic acid, 1,6-hexanedicarboxylic acid, 1,7-heptanedicarboxylic acid, 1,8-octanedicarboxylic acid, 1,9-nonanedicarboxylic acid, 1,10-decanedicarboxylic acid, 1,12-dodecanedicarboxylic acid, 1,14-tetradecanedicarboxylic acid, o-phthalic acid, isophthalic acid, terephthalic acid, 1,3-butadiene-1,4-dicarboxylic acid, p-benzenedicarboxylic acid, perylene-3,9-dicarboxylic acid, perylene dicarboxylic acid, 3,6-dioxaoctanedicarboxylic acid, 3,5-cyclohexadiene-1,2-dicarboxylic acid, 1,4-cyclohexanedicarboxylic acid, 2-benzoylbenzene-1,3-dicarboxylic acid, 2,6-naphthalene dicarboxylic acid, 1,3-adamantane dicarboxylic acid, 1,8-naphthalene dicarboxylic acid, 2,3-naphthalene dicarboxylic acid, anthracene-2,3-dicarboxylic acid, 4,4′-biphenyldicarboxylic acid, 2′3′-diphenyl-p-terphenyl-4,4″-dicarboxylic acid, diphenyl-ether-4,4′-dicarboxylic acid, 5-tert-butyl-1,3-benzenedicarboxylic acid, 4-cyclohexene-1,2-dicarboxylic acid, 5-hydroxy-1,3-benzenedicarboxylic acid, 1-nonene-6,9-dicarboxylic acid, cyclohexene-2,3-dicarboxylic acid, and cyclobutane-1,1-dicarboxylic acid; tricarboxylic acids such as 1,2,3-propanetricarboxylic acid, 1,2,4-butanetricarboxylic acid, 1-hydroxy-1,2,3-propanetricarboxylic acid, 2-hydroxy-1,2,3-propanetricarboxylic acid, 1,2,4-benzenetricarboxylic acid, and 1,3,5-benzenetricarboxylic acid; nitrogen-containing compounds such as pyridine, pyrimidine, pyridazine, pyrazine, triazine, triazole, tetrazole, imidazole, thiazole, oxazole, phenanthroline, quinoline, isoquinoline, naphthyridine, purine, bipyridine (4,4′-bipyridyl), and terpyridine; and the like.

As described above, it is preferable to use a porous coordination polymer having an active site in the present invention. When a porous coordination polymer exhibiting a sigmoidal adsorption behavior is used, ammonia gas can be efficiently adsorbed and recovered with a small pressure change in the present invention. A porous coordination polymer of a combination of the metal ion and the organic ligand is particularly a typical example. Even when a porous coordination polymer exhibits a general Langmuir-type adsorption behavior, it is also possible to use the porous coordination polymer whose adsorption or desorption amount changes steeply due to a pressure change.

As the ammonia-containing gas to be brought into contact with the porous coordination polymer in the contact step, the following may be used as it is: an exhaust gas (hereinafter, referred to as “raw material exhaust gas”) generated at, for example, a site where ammonia or an ammonia-containing chemical is used, such as a semiconductor manufacturing plant and a plant manufacturing a chemical material including hydrogen, a site where ammonia is by-produced, a bam or the like, or ammonia gas generated at an ammonia manufacturing plant. The raw material exhaust gas may contain other gases such as hydrogen fluoride, hydrogen peroxide, and isopropyl alcohol in addition to the ammonia gas depending on the exhaust source, and thus a gas obtained by subjecting the raw material exhaust gas to various treatments (pretreatments) using an alkali scrubber or the like to remove specific components may be used as the ammonia-containing gas. It is also possible to use an ammonia gas obtained by heating and aerating a liquid prepared by reducing the solubility of ammonia, which is obtained by adding an alkali agent such as caustic soda to an ammonia-containing waste liquid generated in the above-mentioned plant or the like, by so-called stripping treatment.

As the ammonia-containing gas, it is preferable to use a gas in which the water content is adjusted to be high by a step of setting the content ratio of water (water vapor) to preferably 106 parts by mass or more relative to 100 parts by mass of the ammonia content at, for example, 20° C. (hereinafter, referred to as “moisture adjusting step”) since the ammonia adsorption effect by the porous coordination polymer becomes remarkable. The content ratio of water is more preferably 110 parts by mass or more, furthermore preferably 202 parts by mass or more, still more preferably 10,000 parts by mass or more, and particularly preferably 100,000 parts by mass or more, but the upper limit is typically 2,260,000 parts by mass. The content ratio of ammonia in the ammonia-containing gas is not particularly limited, and the lower limit is typically 0.00001% by volume.

When the water content in the gas is too high, that is to say, the water content is more than the preferred upper limit value described above, the water content can be adjusted by, for example, bringing a dehydrating agent into contact with the gas in the moisture adjusting step. When the gas does not contain water (water vapor) or contains water in a small amount, and the content ratio thereof is less than 106 parts by mass relative to 100 parts by mass of the ammonia content, it is preferable to adjust the water content by performing a humidification operation using a water scrubber, a porous coordination polymer for moisture adjustment, or the like.

Examples of the contact step include: (1) a method of supplying an ammonia-containing gas into a sealed container in which a composite formed by supporting porous coordination polymer particles or a porous coordination polymer is stored to adsorb ammonia to the porous coordination polymer; (2) a method of supplying an ammonia-containing gas into a sealed container in which a membrane formed of a porous coordination polymer is formed on an inner surface to adsorb ammonia to the porous coordination polymer; (3) a method of introducing an ammonia-containing gas from one end side of a cylindrical container filled with a composite formed by supporting porous coordination polymer particles or a porous coordination polymer to adsorb ammonia to the porous coordination polymer, and exhausting the remaining gas excluding ammonia from the other end side; (4) a method of introducing an ammonia-containing gas from one end side of a cylindrical container (air permeable container) in which a portion (membrane or the like) made of the porous coordination polymer is disposed to adsorb ammonia to the porous coordination polymer, and exhausting the remaining gas excluding ammonia from the other end side; and the like.

In the contact step, the contact conditions of the ammonia-containing gas and the porous coordination polymer for suitably adsorbing ammonia to the porous coordination polymer are not particularly limited. The temperature is preferably, for example, 25° C. or lower. The pressure may be any of normal pressure, reduced pressure, and pressurization in the sealed container or the cylindrical container described above.

In the contact step, other adsorbents may be used as necessary. For example, when the ammonia-containing gas contains gases other than the ammonia gas and water vapor (hereinafter, referred to as “other gases”), an adsorbent that selectively adsorbs other gases can be used. Examples of other adsorbents include other porous coordination polymers having different properties, zeolite, molecular sieve, activated carbon, water, an alkali scrubber, and the like. Other adsorbents may include an adsorbent adsorbing ammonia, but from a viewpoint of the recovery rate of ammonia from the ammonia-adsorbed porous coordination polymer in the ammonia recovery step subsequent to the desorption step, it is preferable to use an adsorbent having an ammonia adsorption capability inferior to that of the porous coordination polymer.

When the other adsorbents are used, the other adsorbents and the porous coordination polymer may coexist as long as the other adsorbent is easily separated from the ammonia-adsorbed porous coordination polymer after the ammonia-containing gas and the porous coordination polymer are brought into contact with each other, and the ammonia-adsorbed porous coordination polymer can be recovered.

The method for using the other adsorbents is not particularly limited as long as the ammonia-adsorbed porous coordination polymer that does not adsorb other gases can be easily recovered before the desorption step. For example, a method for causing the other adsorbents to coexist with the porous coordination polymer, or a method including a second contact step of disposing the other adsorbents in a separate chamber from the porous coordination polymer, and bringing the other adsorbent into contact with an ammonia-containing gas from a viewpoint of the workability in the desorption step may be applied. In the second contact step, if other gases become a factor that causes deterioration of the porous coordination polymer or hinders absorption of ammonia, or if the purity of recovered ammonia is adversely affected, it is preferable that an ammonia-containing gas is first brought into contact with the other adsorbents or a porous coordination polymer other than the porous coordination polymer for adsorption of ammonia to adsorb gases other than ammonia, and then an ammonia-containing gas mainly containing ammonia is brought into contact with the porous coordination polymer. Depending on the purpose, different other adsorbents can also be provided before and after the contact step. The gas from which ammonia has been removed by the porous coordination polymer in the contact step may be subjected to the conventionally known treatment using a sulfuric acid scrubber.

The desorption step is a step of desorbing ammonia from the ammonia-adsorbed porous coordination polymer, that is, the porous coordination polymer to which ammonia is adsorbed, obtained in the contact step. In this desorption step, to efficiently desorb ammonia, it is preferable to expose the ammonia-adsorbed porous coordination polymer to a reduced pressure atmosphere in a sealed space. The pressure in this case may be equal to or lower than the pressure at the time of adsorption of the ammonia-adsorbed porous coordination polymer. As a method for reducing the partial pressure of ammonia, for example, the ammonia-adsorbed porous coordination polymer may be exposed to ammonia-free dry air. The temperature in the reduced-pressure atmosphere is not particularly limited, and may be room temperature or in a heating condition.

In the desorption step, to increase the desorption rate of ammonia, it is preferable to apply a method of increasing the pressure difference as compared with that at the time of adsorption of the ammonia-adsorbed porous coordination polymer, or a method of performing desorption while heating the ammonia-adsorbed porous coordination polymer.

The ammonia recovery step is a step of recovering ammonia obtained in the desorption step. For example, a method of removing the porous coordination polymer from the sealed space used for the desorption step and directly storing ammonia in a container forming the sealed space, or a method of storing the ammonia in a separately disposed storage container may be applied. In the latter case, not only ammonia alone may be stored in the storage container, but also ammonia may be stored in the storage container in a state of being adsorbed (occluded) to a new porous coordination polymer or the other adsorbents.

The porous coordination polymer from which the ammonia has been desorbed can be reused, and thus the method for recycling ammonia of the present invention may include a porous coordination polymer recovery step of recovering the porous coordination polymer, and if necessary, may include a step of regenerating the porous coordination polymer. In the ammonia recycling method of the present invention, after the ammonia recovery step, the exhaust gas may be subjected to a treatment using a conventionally known sulfuric acid scrubber or the like as necessary.

The ammonia recycling method of the present invention can recover high-purity ammonia suitable for reuse. The porous coordination polymer after ammonia desorption can be reused as it is or as necessary by performing a regeneration treatment such as washing.

3. Apparatus for Recycling Ammonia from Ammonia-Containing Gas

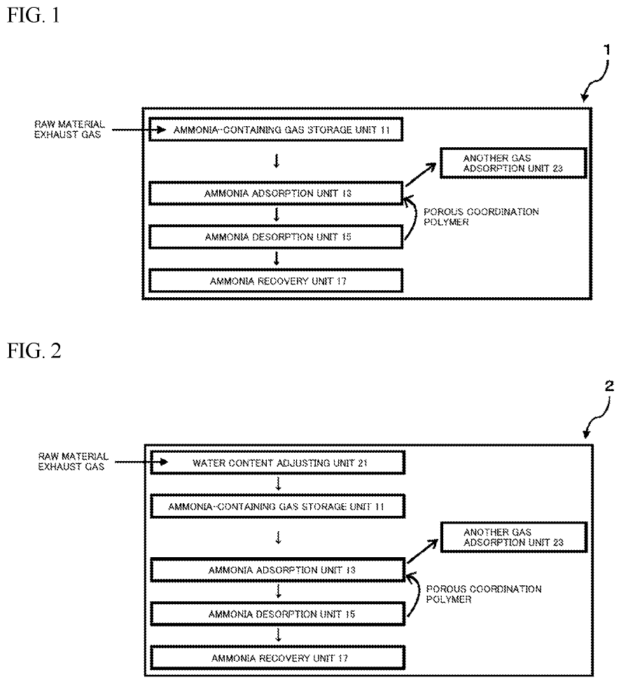

The apparatus for recycling ammonia from an ammonia-containing gas of the present invention is an apparatus reflecting the above-mentioned method for recycling ammonia of the present invention, and may have a configuration shown in, for example, FIG. 1, 2, or 3.

The ammonia recycling apparatus 1 of FIG. 1 includes: an ammonia-containing gas storage unit 11 in which a raw material exhaust gas recovered outside is modified as necessary and stored as an ammonia-containing gas; an ammonia adsorption unit 13 in which a porous coordination polymer is stored, the ammonia-containing gas and the porous coordination polymer are brought into contact with each other to adsorb ammonia in the ammonia-containing gas to the porous coordination polymer; an ammonia desorption unit 15 in which ammonia is desorbed from an ammonia-adsorbed porous coordination polymer formed in the ammonia adsorption unit 13; and an ammonia recovery unit 17 in which the desorbed ammonia is recovered. Although not essential, the ammonia recycling apparatus 1 of FIG. 1 includes the other gas adsorption unit 23 configured to adsorb a gas (other gas) in a state where ammonia is removed in the ammonia adsorption unit 13. When the other gas adsorption unit 23 is disposed, it is not limited to this position, and may be between the ammonia-containing gas storage unit 11 and the ammonia adsorption unit 13, or between the ammonia adsorption unit 13 and the ammonia desorption unit 15.

Although not shown, the ammonia recycling apparatus 1 of FIG. 1 may include a valve, a pump, and the like, between the ammonia-containing gas storage unit 11 and the ammonia adsorption unit 13, between the ammonia desorption unit 15 and the ammonia recovery unit 17, and between the ammonia adsorption unit 13 and the other gas adsorption unit 23. A unit that satisfies intended functions may serve as two or more, or three or more of the storage unit, the adsorption unit, the desorption unit, and the recovery unit.

The ammonia-containing gas storage unit 11 configured to store the ammonia-containing gas is generally made of a sealed container, and the ammonia adsorption unit 13 may include a means for precooling the ammonia-containing gas or the like inside or outside the sealed container in order to facilitate adsorption of ammonia contained in the ammonia-containing gas to the porous coordination polymer.

The ammonia adsorption unit 13 is, in other words, a porous coordination polymer storage unit. In this ammonia adsorption unit 13, the ammonia-containing gas supplied from the ammonia-containing gas storage unit 11 is brought into contact with the stored porous coordination polymer to adsorb ammonia to the porous coordination polymer.

The ammonia adsorption unit 13 may be either a sealed system or a flow system. That is, this ammonia adsorption unit 13 may have a sealed structure or a cylindrical structure in which the porous coordination polymer is stored. The number of the ammonia adsorption units 13 communicating with the ammonia-containing gas storage unit 11 is not particularly limited, and may be one or two or more. In a case where two or more ammonia adsorption units are provided, either series disposition or parallel disposition may be employed.

In the ammonia adsorption unit 13 having a sealed structure, a composite including porous coordination polymer particles or a porous coordination polymer supported is previously stored in a container, or a membrane made of a porous coordination polymer is formed on the inner surface (inner wall) of the container, and ammonia can be adsorbed to the porous coordination polymer while an ammonia-containing gas supplied from the ammonia-containing gas storage unit 11 is retained or circulated in the container.

In the ammonia adsorption unit 13 having a cylindrical structure, the ammonia-containing gas supplied from the ammonia-containing gas storage unit 11 is passed through the cylindrical body to adsorb ammonia to the porous coordination polymer disposed inside the cylindrical body. In this case, an embodiment in which porous coordination polymer particles or a composite formed by supporting a porous coordination polymer are filled previously in the cylindrical body, or an embodiment in which a membrane made of a porous coordination polymer is formed on the inner surface (inner wall) of the cylindrical body may be applied.

The ammonia adsorption unit 13 may include a means for cooling or heating the ammonia-containing gas and the porous coordination polymer, a means for adjusting the pressure in the container, and the like, in order to efficiently adsorb ammonia to the porous coordination polymer.

In the ammonia desorption unit 15, ammonia is desorbed from the ammonia-adsorbed porous coordination polymer formed in the ammonia adsorption unit 13. A means for transferring the ammonia-adsorbed porous coordination polymer to the ammonia desorption unit 15 is not particularly limited. For example, a means for continuously recovering the ammonia-adsorbed porous coordination polymer and transferring it to the ammonia desorption unit 15 may be provided.

In the ammonia desorption unit 15, it is preferable to store the ammonia-adsorbed porous coordination polymer in a sealed container provided with a depressurization means and desorb ammonia. This sealed container may optionally include a heating means.

As shown in FIG. 1, the porous coordination polymer after ammonia desorption may be reused in the ammonia adsorption unit 13. FIG. 1 shows that the porous coordination polymer is supplied from the ammonia desorption unit 15 to the ammonia adsorption unit 13, but the recycling apparatus of the present invention is not limited thereto, and may include a porous coordination polymer regenerating unit (not shown) configured to recover and regenerate the porous coordination polymer from the ammonia desorption unit 15.

The ammonia recovery unit 17 includes a container for storing the ammonia desorbed from the ammonia-adsorbed porous coordination polymer in the ammonia desorption unit 15. The stored material in the ammonia recovery unit 17 may be ammonia only, or may be one in which ammonia is adsorbed (occluded) to a new porous coordination polymer or other adsorbent.

The ammonia recycling apparatus of FIG. 1 may include a conventionally known sulfuric acid scrubber after the ammonia adsorption unit 13 or after the ammonia recovery unit 17 (not shown).

The ammonia recycling apparatus 2 of FIG. 2 includes: a water content adjusting unit 21 configured to prepare an ammonia-containing gas having at least a water content adjusted to a specific range relative to a raw material exhaust gas recovered outside; an ammonia-containing gas storage unit 11 configured to store the ammonia-containing gas; an ammonia adsorption unit 13 configured to store a porous coordination polymer, and bring the ammonia-containing gas into contact with the porous coordination polymer to adsorb ammonia in the ammonia-containing gas to the porous coordination polymer, an ammonia desorption unit 15 configured to desorb ammonia from an ammonia-adsorbed porous coordination polymer obtained in the ammonia adsorption unit 13; and an ammonia recovery unit 17 configured to recover the desorbed ammonia. Although not essential, the ammonia recycling apparatus 2 of FIG. 2 also includes the other gas adsorption unit 23 configured to adsorb a gas (other gas) in a state where ammonia is removed in the ammonia adsorption unit 13. In a case where the other gas adsorption unit 23 is disposed, it is not limited to this position, and may be between the ammonia-containing gas storage unit 11 and the ammonia adsorption unit 13, or between the ammonia adsorption unit 13 and the ammonia desorption unit 15.

Although not shown, the ammonia recycling apparatus 2 of FIG. 2 may include a valve, a pump, and the like between the water content adjusting unit 21 and the ammonia-containing gas storage unit 11.

The water content adjusting unit 21 is preferably a unit that can treat the raw material exhaust gas supplied from the outside to prepare an ammonia-containing gas containing 106 parts by mass or more of water when the content of ammonia is 100 parts by mass.

The raw material exhaust gas generally has different water contents as well as different components depending on the generation site. Therefore, in the water content adjusting unit 21, a dehydrating agent is brought into contact with the raw material exhaust gas when the water content is too high, whereas the humidification operation using a water scrubber, an acid or alkali scrubber, or a porous coordination polymer for moisture content adjustment is performed on the raw material exhaust gas when the water content is too low. In consideration of a case where the raw material exhaust gas contains a component that inhibits adsorption of ammonia to the porous coordination polymer, the water content adjusting unit 21 may include a means for removing the inhibitory component by adsorption, reaction, or the like.

For the ammonia adsorption unit 13, the ammonia desorption unit 15, and the ammonia recovery unit 17 in the ammonia recycling apparatus 2 of FIG. 2, the respective descriptions in the ammonia recycling apparatus 1 of FIG. 1 are applied.

The ammonia recycling apparatus 2 of FIG. 2 may also include a conventionally known sulfuric acid scrubber after the ammonia adsorption unit 13 or after the ammonia recovery unit 17 (not shown).

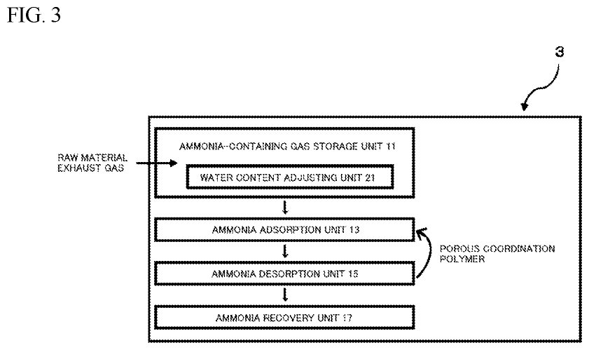

The ammonia recycling apparatus 3 of FIG. 3 includes: an ammonia-containing gas storage unit 11 in which a water content adjusting unit 21 is provided: an ammonia adsorption unit 13 in which a porous coordination polymer is stored, an ammonia-containing gas and the porous coordination polymer are brought into contact with each other to adsorb ammonia in the ammonia-containing gas to the porous coordination polymer; an ammonia desorption unit 15 in which ammonia is desorbed from an ammonia-adsorbed porous coordination polymer obtained in the ammonia adsorption unit 13; and an ammonia recovery unit 17 in which the desorbed ammonia is recovered. Although not shown, the ammonia recycling apparatus 3 of FIG. 3 may also further include the other gas adsorption unit 23 configured to adsorb a gas (other gas) in a state where ammonia is removed in the ammonia adsorption unit 13. The other gas adsorption unit 23 may be provided in front of, or in front and rear of the ammonia adsorption unit 13.

In the ammonia recycling apparatus 3 of FIG. 3, the water content adjusting unit 21 prepares an ammonia-containing gas adjusted to a specific water content in the ammonia-containing gas storage unit 11. This ammonia-containing gas may be set to a gas prepared inside the water content adjusting unit 21 or a gas prepared outside the water content adjusting unit 21 by applying the same means as the water content adjusting unit 21 in the ammonia recycling apparatus 2 of FIG. 2.

For the ammonia adsorption unit 13, the ammonia desorption unit 15, and the ammonia recovery unit 17 in the ammonia recycling apparatus 3 of FIG. 3, the respective descriptions in the ammonia recycling apparatus 1 of FIG. 1 are applied.

The ammonia recycling apparatus 3 of FIG. 3 may also include a porous coordination polymer regenerating unit configured to recover the porous coordination polymer from the ammonia desorption unit 15 for regeneration, and may include a conventionally known sulfuric acid scrubber in rear of the ammonia adsorption unit 13 or in rear of the ammonia recovery unit 17 (both are not shown).

When having a structure that is capable of switching or disconnecting by a valve or the like or a sealed structure in the present invention, the ammonia adsorption unit 13 can also serve as the ammonia desorption unit 15 by having a structure that can further perform pressure adjustment such as decompression and temperature adjustment such as heating (not shown). In this case, parallel disposition allows the adsorption step and the desorption step alternately. In addition to the ammonia desorption at the same place, there may be made such a configuration that the ammonia adsorption unit 13 is separated and moved, and the ammonia desorption is performed at another place where the ammonia adsorbent is used.

4. Method for Recycling Ammonia from Ammonia-Containing Liquid

The method for recycling ammonia from the ammonia-containing liquid containing ammonia and/or ammonium ions of the present invention is a method in which the ammonia-containing liquid is brought into contact with the porous coordination polymer to adsorb ammonia to the porous coordination polymer, and then the ammonia is desorbed from an ammonia-adsorbed porous coordination polymer formed by adsorbing the ammonia to the porous coordination polymer to recover ammonia.

The ammonia-containing liquid to be brought into contact with the porous coordination polymer generally contains water, and may be a waste liquid stock solution generated at, for example, a site where ammonia or an ammonia-containing chemical is used, an ammonia producing site, a site where ammonia is by-produced, or the like in a semiconductor manufacturing plant or a chemical material manufacturing plant using ammonia, and, if necessary, may be a liquid obtained by concentrating this waste liquid stock solution or diluting the waste liquid stock solution with water. Further, a liquid containing ammonia discharged from a living organism may be applied. The above waste liquid stock solution may contain hydrogen fluoride, hydrogen peroxide, a water-soluble organic solvent such as isopropyl alcohol, and the like. Therefore, the stock solution may be subjected to addition of an alkaline agent to be a liquid having a predetermined pH and then to ammonia stripping using a heat exchanger and a stripping tower. The pH of the ammonia-containing liquid to be brought into contact with the porous coordination polymer is not particularly limited. In the present invention, before and after the porous coordination polymer and the ammonia-containing liquid are brought into contact with each other, the pH may be adjusted appropriately by using an acid or an alkali as necessary. The preferable pH of the ammonia-containing liquid is 7.0 or higher, preferably in a range from 9.2 to 12.5, and more preferably from 10.0 to 11.5. In accordance with other substances coexisting in the ammonia-containing liquid, adjustment may be performed from acid to alkaline, or may be performed from alkaline to acid. The alkaline ammonia-containing liquid is brought into contact with the porous coordination polymer, and then an acidic material may be added to the mixed liquid, and in this case, a neutral or acidic liquid may be prepared.

Ammonia is soluble in water. As described above, it is preferable to use a porous coordination polymer having an active site in the present invention, and in particular, the porous coordination polymer having an active site in pores has such a property that aggregates of water are easily formed in the pores. The water adsorption property of such a porous coordination polymer preferably exhibits a sigmoidal adsorption behavior because ammonia can be efficiently recovered by a small pressure change. In the pores of the porous coordination polymer exhibiting a sigmoidal adsorption behavior, aggregation of water allows water-soluble ammonia to easily enter the pores, thereby facilitating adsorption. Even when the porous coordination polymer exhibits a general Langmuir-type adsorption behavior, efficient ammonia recovery can be performed as long as the adsorption and desorption amounts change steeply with a pressure change.

The metal ion constituting such a porous coordination polymer is preferably an ion of a metal selected from Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb, and Bi. The organic ligand is preferably a ligand derived from carboxylic acids or azoles, and compounds that provide such a ligand are as exemplified above.

The shape of the porous coordination polymer is not particularly limited in the present invention. The size of the porous coordination polymer is also not particularly limited, but is preferably a size that causes natural settlement in a liquid. For example, particles having a particle diameter of 1 μm or more may be used as the secondary particles.

In the method for recycling ammonia from an ammonia-containing liquid, it is preferable to bring the porous coordination polymer to which the water-soluble organic solvent has been adhered into contact with the ammonia-containing liquid. The amount of the water-soluble organic solvent adhered to the porous coordination polymer is not particularly limited, but is preferably in a range from 1 to 200 parts by mass, more preferably from 5 to 120 parts by mass, and further preferably from 10 to 100 parts by mass relative to 100 parts by mass of the porous coordination polymer. The form of adhesion of the water-soluble organic solvent is not particularly limited, and the water-soluble organic solvent may be physically adhered onto the surface of or into pores of the porous coordination polymer, or the water-soluble organic solvent may be chemically bonded (coordinate-bonded) to the porous coordination polymer. In the latter case, molecules of the water-soluble organic solvent may be coordinated to the open metal site.

The water-soluble organic solvent is not particularly limited as long as it is soluble in water at a temperature of 0° C. Examples thereof include alcohols (monohydric alcohol, polyhydric alcohol), glycols, ethers, ketones, nitrogen-containing compounds, sulfur-containing compounds, and the like. The water-soluble organic solvent adhered to the porous coordination polymer may be singly or in combination of two or more types thereof.

Examples of the alcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, trimethylolpropane, trimethylolethane, and the like.

Examples of the glycols include ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, glycerin, and the like.

Examples of the ethers include: glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether; cyclic ethers such as tetrahydrofuran; and the like.

Examples of the ketones include acetone, diethyl ketone, methyl propyl ketone, methyl butyl ketone, methyl isopropyl ketone, methyl isobutyl ketone, methyl amyl ketone, diisopropyl ketone, methyl ethyl ketone, and the like.

Examples of the nitrogen-containing compounds include N,N-dimethylformamide, N,N-dimethylacetamide, 2-pyrrolidone, N-methyl-2-pyrrolidone, N-ethyl-2-pyrrolidone, and the like.

Examples of the sulfur-containing compounds include dimethyl sulfoxide, and the like.

The method for preparing the porous coordination polymer to which the water-soluble organic solvent is adhered is not particularly limited. Example of the preferred preparation method include a method in which a particulate porous coordination polymer and a water-soluble organic solvent are placed in a container, stirred, and then filtered and dried to remove most of the water-soluble organic solvent. When the porous coordination polymer and the water-soluble organic solvent are stirred, the mixture may be heated. In this case, the upper limit of the heating temperature is generally 230° C.

A method of bringing an ammonia-containing liquid and a porous coordination polymer (also including a porous coordination polymer to which a water-soluble organic solvent is adhered, the same applies hereinafter) into contact with each other is exemplified below.

(1) A method of supplying an ammonia-containing liquid to a container storing a porous coordination polymer and stirring the ammonia-containing liquid as necessary to adsorb ammonia to the porous coordination polymer.
(2) A method of supplying an ammonia-containing liquid to a container in which a membrane made of a porous coordination polymer is formed on the inner surface (inner wall) and stirring the ammonia-containing liquid as necessary to adsorb ammonia to the porous coordination polymer.
(3) A method of introducing an ammonia-containing liquid from one end side of a cylindrical container filled therein with a composite formed by supporting porous coordination polymer particles or a porous coordination polymer to adsorb ammonia to the porous coordination polymer, and discharging a remaining liquid excluding ammonia from the other end side.
(4) A method of introducing an ammonia-containing liquid from one end side of a cylindrical container (air permeable container) in which a portion (membrane or the like) made of a porous coordination polymer is disposed to adsorb ammonia to the porous coordination polymer, and discharging a remaining liquid excluding ammonia from the other end side.
(5) A method of mixing a granular or massive porous coordination polymer and an ammonia-containing liquid in a container to perform contact and adsorption, and then performing precipitation separation to recover the porous coordination polymer.

In a case where the ammonia-containing liquid to be brought into contact with the porous coordination polymer contains a water-soluble organic solvent, when a porous coordination polymer to which the water-soluble organic solvent is not adhered is brought into contact with the ammonia-containing liquid, a porous coordination polymer to which the water-soluble organic solvent is adhered is formed in the ammonia-containing liquid. In this case, the same effect as in the case of using the porous coordination polymer to which the water-soluble organic solvent is adhered can be obtained. Therefore, when using the porous coordination polymer to which the water-soluble organic solvent is not adhered, it is preferable to confirm the composition of the ammonia-containing liquid previously, and to pretreat the liquid as necessary.

The contact condition between the ammonia-containing liquid and the porous coordination polymer is not particularly limited. The temperature may be, for example, in a range from −10° C. to 30° C. for both the ammonia-containing liquid and the porous coordination polymer, or one or both of them may be in a heated state, for example, at 60° C. or higher.

When the ammonia-containing liquid and the porous coordination polymer are brought into contact with each other, other adsorbents may be used as necessary. For example, in a case where the ammonia-containing liquid contains a component other than ammonia (hereinafter, referred to as “other components”), an adsorbent that selectively adsorbs other components may be used. Examples of the other adsorbents include other porous coordination polymers having different properties, zeolite, molecular sieve, activated carbon, and the like. Other adsorbents may adsorb ammonia, but from a viewpoint of the recovery rate of ammonia in the case of the subsequent desorbing and recovery of ammonia from the ammonia-adsorbed porous coordination polymer, it is preferable to use an adsorbent having an ammonia adsorption capability inferior to that of the porous coordination polymer as the other adsorbents. When a component that inhibits recovery of ammonia or a component that adversely affects the purity of recovered ammonia is contained, a method such as flocculation precipitation separation may be combined as the pretreatment.

The other adsorbent may coexist with the porous coordination polymer as long as the ammonia-containing liquid and the porous coordination polymer are brought into contact with each other, then the other adsorbents are easily separated from the ammonia-adsorbed porous coordination polymer, and the ammonia-adsorbed porous coordination polymer can be recovered.

After the contact between the ammonia-containing liquid and the porous coordination polymer, the formed ammonia-adsorbed porous coordination polymer is recovered from the mixed liquid and subjected to desorption of ammonia. The ammonia desorption method is not particularly limited, but it is preferable to expose the ammonia-adsorbed porous coordination polymer to a reduced-pressure atmosphere in a sealed space, or to perform heating, ventilation, passing of water, or a combination of these operations. The method for recovering the ammonia-adsorbed porous coordination polymer from the mixed liquid is not particularly limited, and for example, a method of naturally precipitating the ammonia-adsorbed porous coordination polymer, removing the upper liquid, and recovering a precipitate, or a method of using various dehydrators such as a filter press, a belt press, and a centrifuge may be applied.

In the present invention, when the porous coordination polymer is brought into contact with the ammonia-containing liquid adjusted to be alkaline, ammonia can be efficiently adsorbed to the porous coordination polymer. The obtained ammonia-adsorbed porous coordination polymer may be recovered as it is to desorb ammonia from the ammonia-adsorbed porous coordination polymer, but a method of bringing the recovered ammonia-adsorbed porous coordination polymer into contact with a liquid having a pH of, for example, 9.2 or lower, preferably 7.0 or lower, more preferably 6.0 or lower, and further preferably 5.0 or lower to recover ammonia contained in the liquid may be applied.

In the present invention, when the ammonia-containing liquid adjusted to be alkaline is brought into contact with the porous coordination polymer to adsorb ammonia, and then the mixed liquid is adjusted to be acidic, an ammonia-adsorbed porous coordination polymer with selective strong adsorption to the active site can be obtained. In this case, the pH at the time of acidification is preferably 7.0 or lower, more preferably 6.0 or lower, and further preferably 5.0 or lower. When ammonia is desorbed from such an ammonia-adsorbed porous coordination polymer, high-purity ammonia can be efficiently provided.

In general, in the case of removing fluorine or heavy metals from a solution containing thereof, a procedure of insolubilizing the component(s) by adjusting the pH of the solution and removing the formed insolubilized product may be applied. In a case where the ammonia-containing liquid contains components other than ammonia, such as fluorine and heavy metals, and it is necessary to remove other contained components in parallel with ammonia recovery, pH adjustment and removal of other components may be performed in combination.

The ammonia desorbed from the ammonia-adsorbed porous coordination polymer can be separated from the porous coordination polymer and stored in the container as it is, or can be stored in a separately disposed storage container. In the latter case, not only ammonia alone can be stored in the storage container, but also ammonia can be stored in the storage container in a state of being adsorbed (occluded) to a new porous coordination polymer or other adsorbents. On the other hand, the porous coordination polymer after ammonia desorption can be reused, and thus typically recovered, and can be reused by performing a regeneration treatment such as washing as necessary.

In the present invention, the method for recycling ammonia from an ammonia-containing liquid is achieved by an ammonia recycling apparatus to be described later, and it is possible to achieve high-order ammonia recycling in combination with the ammonia recycling apparatus and a stripping apparatus including an ammonia recovery means using a porous coordination polymer, the stripping apparatus reducing the solubility of ammonia by, for example, adding an alkali agent such as caustic soda to the ammonia-containing liquid, and transferring ammonia gas to a gas phase by heating and aerating the liquid.

5. Apparatus for Recycling Ammonia from Ammonia-Containing Liquid

An apparatus for recycling ammonia from an ammonia-containing liquid of the present invention is an apparatus reflecting the method for recycling ammonia of the present invention, and includes: an ammonia-containing liquid storage unit configured to store an ammonia-containing liquid to be treated; an ammonia adsorption unit configured to store a porous coordination polymer and bring the ammonia-containing liquid supplied from the ammonia-containing liquid storage unit into contact with the porous coordination polymer to adsorb ammonia in the ammonia-containing liquid to the porous coordination polymer; an ammonia desorption unit configured to desorb ammonia from an ammonia-adsorbed porous coordination polymer obtained in the ammonia adsorption unit; and an ammonia recovery unit configured to recover ammonia. A unit that satisfies intended functions may serve as two or more, or three or more of the storage unit, the adsorption unit, the desorption unit, and the recovery unit.

The ammonia-containing liquid storage unit may include a means for preheating or cooling the ammonia-containing liquid, a means for adjusting the pH of the ammonia-containing liquid, and the like in order to facilitate adsorption of ammonia to the porous coordination polymer in the ammonia adsorption unit.

The ammonia adsorption unit, the ammonia desorption unit, and the ammonia recovery unit in the apparatus for recycling ammonia from an ammonia-containing liquid of the present invention may be the same as those in the above-mentioned ammonia recycling apparatus from an ammonia-containing gas according to the present invention. Since a porous coordination polymer to which a water-soluble organic solvent is previously adhered before the porous coordination polymer comes into contact with the ammonia-containing liquid can be used as the porous coordination polymer to be brought into contact with the ammonia-containing liquid in the ammonia adsorption unit, the ammonia adsorption unit may include a means for preparing such a porous coordination polymer with a water-soluble organic solvent. For example, a means (spray apparatus) for supplying a water-soluble organic solvent from the outside to bring the water-soluble organic solvent into contact with the porous coordination polymer, a stirring means, and the like may be further included.

### 6. Ammonia Gas Storage Apparatus

An ammonia gas storage apparatus of the present invention includes: an ammonia gas storage unit configured to include a porous coordination polymer, adsorb ammonia gas supplied from the outside (an ammonia gas supply source or the like) to the porous coordination polymer, and hold the ammonia gas in an adsorbed state; and a pressure control unit configured to adjust a pressure in the ammonia gas storage unit. The number of the ammonia gas storage unit and the number of the pressure control unit are not particularly limited, and may be one or two or more. As in the method for recycling ammonia of the present invention, the porous coordination polymer may be used singly, or may be used as a composite formed by supporting the porous coordination polymer on the surface of the support.

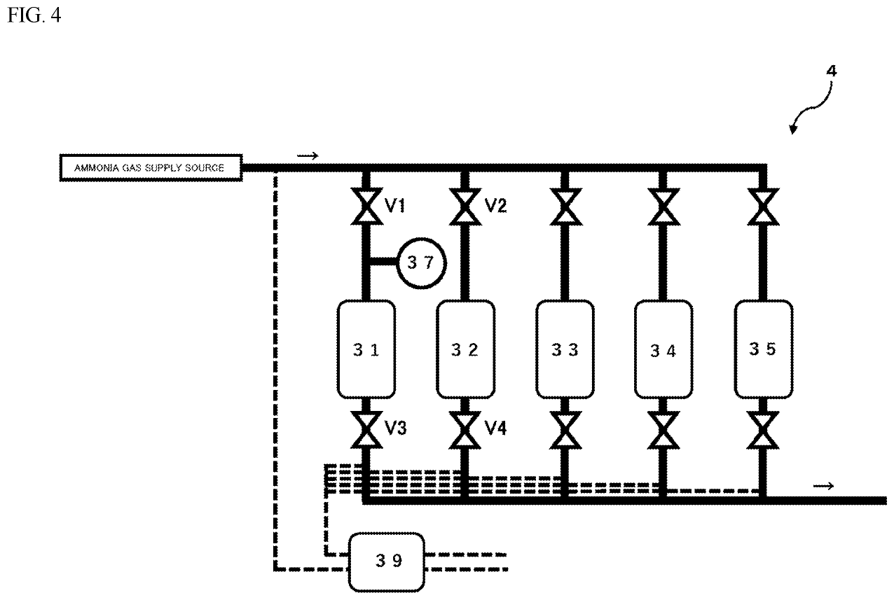

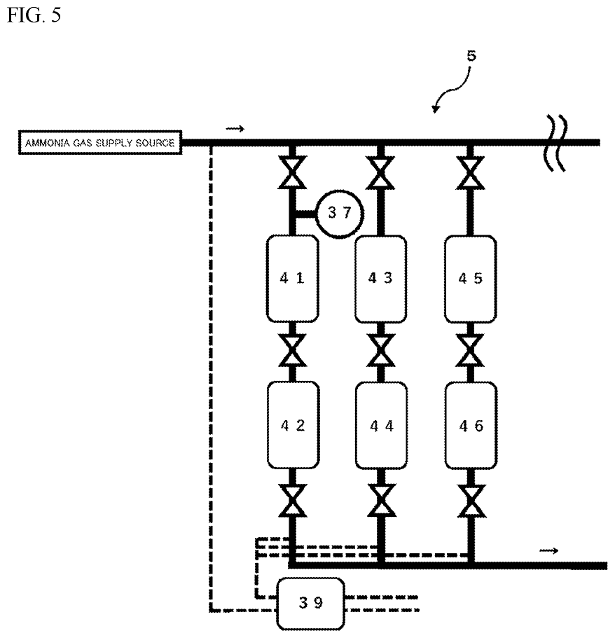

The ammonia gas storage apparatus of the present invention may have, for example, the configuration shown in FIGS. 4 and 5, and includes an ammonia gas storage unit (31 and the like, 41 and the like) and a pressure control unit 37. The ammonia gas storage unit typically includes an introduction port and an exhaust port for ammonia gas.

An ammonia gas storage apparatus 4 of FIG. 4 is a storage apparatus including a plurality of ammonia gas storage units, and includes ammonia gas storage units 31 to 35 connected in parallel from an ammonia gas supply source via a pipe, and the pressure control unit 37 disposed in front of the ammonia gas storage unit 31. In the drawing, broken lines are sampling lines, and are connected to a breakthrough detection unit 39 in order to detect breakthrough in the ammonia gas storage units 31 to 35.

A usage example of the ammonia gas storage apparatus 4 is described on the assumption that the internal volumes of the ammonia gas storage units 31 to 35 are the same and the amounts of the stored porous coordination polymer filled in the ammonia gas storage units 31 to 35 are the same. First, when valves V1 and V3 are opened, valves V2 and V4 and the remaining valves are closed, and the ammonia gas is supplied from the ammonia gas supply source to the ammonia gas storage unit 31, a predetermined amount of ammonia gas is detected in the breakthrough detection unit 39. In this case, the ammonia adsorption rate per unit mass or unit volume of the porous coordination polymer stored in the ammonia gas storage unit 31 by the pressure control unit 37 can be confirmed. A preferable ammonia gas supply rate to the ammonia gas storage unit 31 and an ammonia storage amount in the ammonia gas storage unit 31 can be estimated. Therefore, when the estimated amount of ammonia gas is supplied, the valves V1 and V3 are closed, and then the valves V2 and V4 are opened, so that the same amount of ammonia gas is supplied and stored in the ammonia gas storage unit 32. Repeating this operation can efficiently store the ammonia gas up to the ammonia gas storage unit 35.

As the breakthrough detection unit 39, for example, a heat transfer detector (TCD), a gas chromatograph detector (GC), or the like can be used. In the ammonia gas storage units 31 to 35, the ammonia gas reaches the expected storage amount, and then the valves V3 and V4 and the like on the downstream side of each of the ammonia gas storage unit are opened to discharge and use the ammonia gas.

Making the ammonia gas storage unit detachable from the storage apparatus allows the ammonia gas storage unit to serve as a relocatable ammonia gas tank or a portable cartridge type ammonia gas storage container. Therefore, the ammonia gas storage apparatus of the present invention can be an apparatus for producing an ammonia gas filled body.

An ammonia gas storage apparatus 5 of FIG. 5 includes a plurality of ammonia gas storage units 41 to 46 connected in parallel from an ammonia gas supply source via pipes, and the pressure control unit 37 disposed in front of the ammonia gas storage unit 41. In this ammonia gas storage apparatus 5, the ammonia gas storage units 41 and 42 are connected in series, the ammonia gas storage units 43 and 44 are connected in series, and the ammonia gas storage units 45 and 46 are connected in series. Similarly to the ammonia gas storage apparatus 3 of FIG. 4, the ammonia gas storage apparatus 5 includes the breakthrough detection unit 39 for detecting breakthrough in the ammonia gas storages units 41 to 46.

The ammonia gas storage apparatus 5 of FIG. 5 can also be used in the same manner as the ammonia gas storage apparatus 4 of FIG. 4.

With the ammonia gas storage apparatus of the present invention, appropriately adjusting moisture can adsorb and store ammonia as ammonium ions on the porous coordination polymer. If ammonium ions are used as a hydrogen carrier, the ratio of hydrogen atoms per ammonia can be increased, and therefore the ammonium ions can also be suitably used as a hydrogen storage apparatus.

Further, when the ammonium ions are desorbed from the porous coordination polymer to which the ammonium ions have been adsorbed, the ammonium ions are desorbed into the gas phase by an operation such as decompression, forming a system in which the ammonium ions, hydrogen molecules generated by partial dissociation from the ammonium ions, and ammonia molecules coexist, and then bringing ammonia into contact with and adsorbing to the porous coordination polymer can control the equilibrium between the ammonium ions, hydrogen, and ammonia to extract hydrogen. Therefore, the ammonia gas storage apparatus of the present invention can also be used as a hydrogen production apparatus using ammonia and a porous coordination polymer.

In the present invention, when a gas derived from, for example, the raw material exhaust gas and suitable for storing ammonia is directly stored in the ammonia gas supply source, the gas can be directly adsorbed and stored in the ammonia gas storage apparatus of the present invention instead of the ammonia adsorption unit 13 in FIGS. 1 to 3.

The ammonia adsorption method is a method for adsorbing ammonia as ammonium ions by bringing a gas containing ammonia (ammonia-containing gas) into contact with a porous coordination polymer (hereinafter, referred to as “first porous coordination polymer”) formed by coordinate-bonding a metal ion and an organic ligand, in which when the mass of ammonia is regarded as 100 parts by mass, an ammonia-containing gas adjusted to contain 106 parts by mass or more of water is brought into contact with the first porous coordination polymer. Examples of a method for bringing the ammonia-containing gas into contact with the first porous coordination polymer include: (1) a method of supplying an ammonia-containing gas into a sealed container that stores particles made of the first porous coordination polymer or a composite formed by supporting the first porous coordination polymer to adsorb ammonium ions to the first porous coordination polymer; (2) a method of supplying the ammonia-containing gas into a sealed container in which a membrane made of the first porous coordination polymer is formed on an inner surface thereof to adsorb ammonium ions to the first porous coordination polymer; (3) a method of introducing the ammonia-containing gas from one end side of a cylindrical container filled therein with particles made of the first porous coordination polymer or the composite formed by supporting the first porous coordination polymer to adsorb ammonium ions to the first porous coordination polymer; and (4) a method of introducing the ammonia-containing gas from one end side of a cylindrical container (air permeable container) in which a portion (membrane or the like) made of the first porous coordination polymer is disposed therein to adsorb ammonium ions to the first porous coordination polymer.

According to this ammonia adsorption method, ammonium ions can be efficiently adsorbed to the first porous coordination polymer as compared with the case of using an ammonia-containing gas having less moisture, and further, in the case of trapping ammonia as a hydrogen carrier, converting to ammonium ions allows more hydrogen to be adsorbed per molecule as compared with ammonia.

In the ammonia adsorption method, exposing the first porous coordination polymer to which ammonium ions have been adsorbed under a reduced pressure condition desorbs the ammonium ions in a gas phase, and allows forming of a system in which ammonium ions, hydrogen molecules generated by partial dissociation from the ammonium ions, and ammonia molecules coexist. Exposing a separately prepared porous coordination polymer, which may be the same as or different from the first porous coordination polymer, to the system allows ammonium ions and ammonia molecules to be adsorbed to this porous coordination polymer.

A method for storing ammonia is characterized in that a gas containing ammonia (ammonia-containing gas) is brought into contact with the porous coordination polymer to adsorb the ammonia as ammonium ions. The ammonia-containing gas is preferably adjusted to contain 106 parts by mass or more of water when the mass of ammonia is regarded as 100 parts by mass. As a method for bringing the ammonia-containing gas into contact with the porous coordination polymer, the contact method exemplified in the above-described ammonia adsorption method of the present invention can be applied.

### EXAMPLES

Hereinafter, the present invention will be described in detail using examples.

### 1. Preparation of Porous Coordination Polymer

A porous coordination polymer containing C₂₄H₁₇O₁₆Cr₃ (hereinafter, referred to as “MIL101(Cr)”) was synthesized.

### Synthesis Example 1

1.6 g of chromium (III) nitrate nonahydrate, 665 mg of terephthalic acid, 0.35 mL of 35% hydrochloric acid, and 19.2 g of water were placed in an autoclave, and reacted at a temperature of 220° C. for 8 hours to obtain a reaction liquid containing a green solid component.

This reaction solution was then subjected to suction filtration, and the solid component was sufficiently washed using pure water to recover a green residue (hereinafter, referred to as “residue R1”). The residue R1 and N,N-dimethylformamide (DMF) were put in an eggplant flask and stirred at 60° C. for 6 hours. The amount of DMF used was 150 mL for 1 g of the residue R1. Thereafter, suction filtration was performed to recover a green residue (hereinafter, referred to as “residue R2”). This residue R2 and pure water were then put into an eggplant flask, and subjected to heating while stirring and suction filtration in the same manner as in the case using DMF, thereby recovering a green residue (hereinafter, referred to as “residue R3”). Subsequently, this residue R3 and ethanol were placed in an eggplant flask, and subjected to heating while stirring and suction filtration in the same manner as in the case using DMF, thereby recovering a green residue (hereinafter, referred to as “residue R4”).

After that, this residue R4 was devolatilized at 105° C. for 15 hours in the air using an electric furnace, thereby providing a porous coordination polymer mainly composed of MIL101(Cr) (hereinafter, referred to as “porous coordination polymer A1”). MIL101(Cr) was confirmed by X-ray diffraction.

### Synthesis Example 2

The residue R1 was brought into contact with DMF, pure water, and ethanol in this order in the same manner as in Synthesis Example 1, and then the obtained R4 was dried at room temperature for 24 hours to obtain a porous coordination polymer (hereinafter, referred to as “porous coordination polymer A2”) mainly composed of MIL101(Cr). The amount of ethanol adhered was 0.7 g per 1 g of the porous coordination polymer A2.

### 2. Adsorption Test Using Ammonia-Containing Liquid

### Experimental Example 1-1

As the ammonia-containing liquid, a 1% by mass of ammonium sulfate aqueous solution (pH 5.47, total nitrogen amount: 2077 mg/L) was used.

To 100 mL of the above ammonium sulfate aqueous solution, 1 g of the porous coordination polymer A1 was added and stirred. The liquid had pH of 4.27, the total carbon amount was 230 mg/L, and the total nitrogen amount was 2114 mg/L.

After that, 2 mL of a 25% sodium hydroxide aqueous solution was added to set the pH of the solution to 11.61, and the solution was stirred at 25° C. for 1 hour. Consequently, the total carbon amount was 762 mg/L and the total nitrogen amount was 1779 mg/L.

Subsequently, 0.5 mL of a 78% aqueous sulfuric acid solution was added to adjust the pH of the solution to 4.20, and the mixture was stirred at 25° C. for 1 hour, and consequently the total carbon amount was 432 mg/L and the total nitrogen amount was 1748 mg/L.

From Experimental Example 1-1, the following can be found. Adsorption of ammonia did not occur only by adding the porous coordination polymer A1 to the ammonia-containing liquid having a pH of 5.47. But ammonia was able to be adsorbed to the porous coordination polymer A1 when the liquid was subjected to alkaline adjustment (see Table 1). The amount of ammonia adsorbed at a pH of 11.61 was calculated to be 36.2 mg per 1 g of the porous coordination polymer A1. After that, when sulfuric acid was used to prepare an acidic liquid, the amount of ammonia adsorbed was calculated to be 40.0 mg. At room temperature, even after the pH of the solution was adjusted to 4.2, that is, acidic, ammonia remained and was not desorbed. The porous coordination polymer A1 (MIL101(Cr)) synthesized in Synthesis Example 1 has an open metal site-type active site. The theoretical amount of ammonium adsorbed to the open metal site of the porous coordination polymer A1 is calculated to be about 46 mg per 1 g of the porous coordination polymer A1, and the theoretical value of adsorption to the open metal site approximates the ammonia amount retained under acidic conditions in the experiment. This result suggests that ammonia in the alkaline state is selectively strongly adsorbed to the open metal site, and the ammonia adsorbed to the active site is stably adsorbed even when the liquid property is made acidic. Using this result, appropriately selecting a desorption means provides high-purity ammonia selectively adsorbed to the active site from the ammonia adsorbent.

TABLE 1

| | | TOC | TN | TN difference (N₀ − Nₙ) | NH₃ |
|---|---|---|---|---|---|
| | pH | (mg/L) | (mg/L) | (mg/L) | (mg)/(1 g − A1) |
| 1 wt % ammonium sulfate aqueous solution | 5.47 | | N₀: 2077 | 0 | 0 |
| After addition of porous coordination polymer A1 | 4.27 | 230 | N₁: 2144 | −37 | −0.4 |
| After addition of sodium hydroxide aqueous solution | 11.61 | 762 | N₂: 1779 | 298 | 36.2 |
| After addition of aqueous sulfuric acid solution | 4.20 | 432 | N₃: 1748 | 329 | 40.0 |

### Experimental Example 1-2

As a sample corresponding to the ammonia-containing liquid, a 1% by mass of ammonium sulfate aqueous solution (pH 5.8, total carbon amount: 45 mg/L, total nitrogen amount: 2321 mg/L) was used.

To 100 mL of the ammonium sulfate aqueous solution, 0.5 g of the porous coordination polymer A2 was added and stirred. The liquid had pH of 5.6, the total carbon amount was 1344 mg/L, and the total nitrogen amount was 2296 mg/L.

After that, 2 mL of a 25% sodium hydroxide aqueous solution was added to set the pH of the solution to 11.1, and the solution was stirred at 25° C. for 1 hour. Consequently, the total carbon amount was 1682 mg/L and the total nitrogen amount was 1969 mg/L.

Subsequently, 0.5 mL of a 78% aqueous sulfuric acid solution was added to adjust the pH of the solution to 4.1, and the mixture was stirred at 25° C. for 1 hour. Consequently, the total carbon amount was 1395 mg/L and the total nitrogen amount was 2170 mg/L.

The liquid (pH 4.1) after adding the 78% aqueous sulfuric acid solution was filtered using filter paper, and the obtained filtrate was subjected to ICP emission spectrometry. The quantitative value of Cr contained in the porous coordination polymer A2 was 0.7 mg/L. Since this value was less than 1 mg/L, it is considered that the structure of the porous coordination polymer A2 was maintained in the above experiment.

From Experimental Example 1-2, the following can be found. Adsorption of ammonia did not occur only by adding the porous coordination polymer A2 to the ammonia-containing liquid having a pH of 5.8. But ammonia was able to be adsorbed to the porous coordination polymer A2 when the liquid was subjected to alkaline adjustment. The amount of ammonia adsorbed at a pH of 11.1 was calculated to be 85.5 mg per 1 g of the porous coordination polymer A2. Immersing the porous coordination polymer A2 to which ammonia had been adsorbed into an acidic liquid easily desorbed a part of ammonia into the solution, and this ammonia was able to be recovered. The amount of ammonia remaining as being adsorbed in the acidic liquid was 36.7 mg, which is considered to be ammonia adsorbed to the open metal site of the porous coordination polymer A2 as in Experimental Example 1-1 (see Table 2).

TABLE 2

| | | TOC | TN | TN difference (N₀ − Nₙ) | NH₃ |
|---|---|---|---|---|---|
| | pH | (mg/L) | (mg/L) | (mg/L) | (mg)/(1 g − A2) |
| 1 wt % ammonium sulfate aqueous solution | 5.8 | 45 | N₀: 2321 | 0 | 0 |
| After addition of porous coordination polymer A2 | 5.6 | 1344 | N₁: 2296 | 25 | 6.1 |
| After addition of sodium hydroxide aqueous solution | 11.1 | 1682 | N₂: 1969 | 352 | 85.5 |
| After addition of aqueous sulfuric acid solution | 4.1 | 1395 | N₃: 2170 | 151 | 36.7 |

From the results of Experimental Examples 1-1 and 1-2, the following can be found.

As compared with the porous coordination polymer A1 obtained by heating at 105° C. for 15 hours to devolatilize and remove ethanol after synthesis to, it was possible to adsorb more ammonia when the liquid was adjusted to be alkaline by using the porous coordination polymer A2 to which ethanol had been adhered, obtained by natural drying at room temperature for 24 hours without heating for devolatilization.

In both Experimental Examples 1-1 and 1-2, when acidifying the liquid containing the porous coordination polymer to which ammonia has been adsorbed, ammonia remaining without being desorbed is present, and this is considered to be ammonia stably adsorbed to the open metal site-type active sites of the porous coordination polymers A1 and A2. Therefore, high-purity ammonia can be recovered from the ammonia-adsorbed porous coordination polymer after the ammonia-adsorbed porous coordination polymer is separated and recovered from the acidified solution.

It is considered that in Experimental Example 1-2, the ammonia desorbed when acidifying the liquid containing the porous coordination polymer to which ammonia had been adsorbed was not stably adsorbed to the active site, and the adsorption was promoted by the presence of the water-soluble organic solvent, which increased the affinity between water as the main component of the solution and ammonia in the pores other than the active site of the porous coordination polymer.

### 3. Ammonia Gas Adsorption Test

As a test gas simulating an ammonia-containing gas, a gas prepared from ammonia water was used. The ammonia gas generated from the ammonia water contained water vapor, and thus not only the ammonia gas containing water vapor but also an ammonia gas obtained by removing water vapor using a moisture absorbent was used as a test gas.

The recovered porous coordination polymer A1 after use in Experimental Example 1-1 was sufficiently washed with pure water, and dried at a temperature of 105° C. for 15 hours using an electric furnace to obtain a porous coordination polymer (hereinafter, referred to as “porous coordination polymer AX”). For this porous coordination polymer AX, adsorption tests of the ammonia gas containing water vapor and the ammonia gas not containing water vapor were performed.

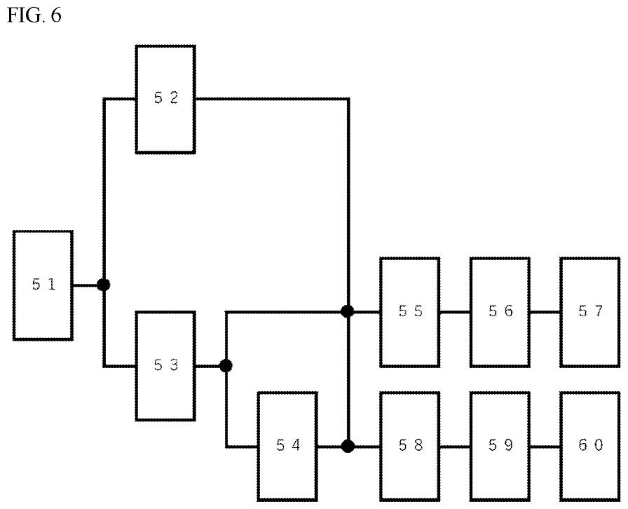

FIG. 6 is a schematic view of an adsorption test apparatus and the apparatus has a cartridge first ammonia adsorption unit 56 and a cartridge second ammonia adsorption unit 59 each storing about 1 g of the porous coordination polymer AX; an air pump 51 configured to supply air as a carrier gas; a first moisture absorption unit 52 configured to store calcium chloride and bring the air supplied from the air pump 51 into contact with the calcium chloride to prepare dry air; an ammonia water storage unit 53 configured to store a 3% by mass of ammonia water (200 mL) and volatilize ammonia gas containing water vapor (hereinafter, this mixed gas is also referred to as “raw material ammonia gas”) from the ammonia water, a second moisture absorption unit 54 (moisture absorption tower) configured to store sodium hydroxide and soda lime at a mass ratio of 1:1 and dehydrate (for removing water vapor) the raw material ammonia gas from the ammonia water storage unit 53 to prepare ammonia gas not containing water vapor; an air flow meter 55 configured to measure a gas amount when a raw material ammonia gas containing water vapor is supplied to the first ammonia adsorption unit 56; a first sulfuric acid scrubber 57, which is a conventionally known ammonia detoxification apparatus, configured to synthesize ammonium sulfate using an aqueous sulfuric acid solution composed of 2 mL of 78% sulfuric acid and 180 mL of pure water, an air flow meter 58 configured to measure a gas amount when ammonia gas not containing water vapor is supplied to the second ammonia adsorption unit 59; and a second sulfuric acid scrubber 60 using an aqueous sulfuric acid solution similarly to the first sulfuric acid scrubber.

### Experimental Example 2-1

An experiment was performed in which a raw material ammonia gas containing 120 parts by mass of water as water vapor relative to 100 parts by mass of ammonia was supplied to the first ammonia adsorption unit 56 storing 0.98 g of the porous coordination polymer AX.

First, to adjust the state of the porous coordination polymer AX, air from the air pump 51 was used as dry air in the first moisture absorption unit 52, and the dry air was supplied to the first ammonia adsorption unit 56 at a flow rate of 0.2 L per minute for 1 hour.

Subsequently, using the air supplied from the air pump 51 as a carrier gas, the raw material ammonia gas obtained by volatilizing in the ammonia water storage unit 53 was supplied to the first ammonia adsorption unit 56 at a flow rate of 0.2 L per minute. After 3 hours, aeration was stopped and the aqueous sulfuric acid solution in the first sulfuric acid scrubber 57 was replaced. The dry air was then supplied to the first ammonia adsorption unit 56 at a flow rate of 0.2 L per minute for 15 hours to desorb ammonia, and the ammonia was absorbed into the aqueous sulfuric acid solution (new aqueous sulfuric acid solution) in the first sulfuric acid scrubber 57. The first sulfuric acid scrubber 57 was washed with pure water, and the aqueous sulfuric acid solution was recovered and diluted in a 200 mL measuring flask. The total nitrogen amount of the recovered liquid was measured, and the ammonia amount was calculated to be 36.1 mg per 1 g of the porous coordination polymer AX. On the other hand, the porous coordination polymer AX in the first ammonia adsorption unit 56 was placed in 100 mL of an aqueous sulfuric acid solution (pH 3), stirred at 25° C. for 1 hour, and then filtered using filter paper. The total nitrogen amount of the recovered filtrate (hereinafter, also referred to as “recovered liquid AL1”) was measured, and the ammonia amount was calculated to be 12.1 mg per 1 g of the porous coordination polymer AX.

As described above, it has been found that when the raw material ammonia gas containing water vapor is adsorbed, a total of 48.2 mg of ammonia is adsorbed per 1 g of the porous coordination polymer AX.

### Experimental Example 2-2

An experiment was performed in which an ammonia gas not containing water vapor was supplied to the second ammonia adsorption unit 59 storing 0.99 g of the porous coordination polymer AX.

First, to adjust the state of the porous coordination polymer AX, air from the air pump 51 was used as dry air in the first moisture absorption unit 52, and the dry air was supplied to the second ammonia adsorption unit 59 at a flow rate of 0.2 L per minute for 1 hour.

Subsequently, using the air supplied from the air pump 51 as a carrier gas, the raw material ammonia gas obtained by volatilizing in the ammonia water storage unit 53 was supplied to the second moisture absorption unit 54 containing sodium hydroxide and soda lime at a flow rate of 0.2 L per minute to dehydrate (for removing water vapor), and an ammonia gas not containing water vapor was prepared and continuously supplied to the second ammonia adsorption unit 59. After 3 hours, aeration was stopped and the aqueous sulfuric acid solution in the second sulfuric acid scrubber 60 was replaced. The dry air was then supplied to the second ammonia adsorption unit 59 at a flow rate of 0.2 L per minute for 15 hours to desorb ammonia, and the ammonia was absorbed into the aqueous sulfuric acid solution (new aqueous sulfuric acid solution) in the second sulfuric acid scrubber 60. The second sulfuric acid scrubber 60 was washed with pure water, and the aqueous sulfuric acid solution was recovered and diluted in a 200 mL measuring flask. The total nitrogen amount of the recovered liquid was measured, and the ammonia amount was calculated to be 12.8 mg per 1 g of the porous coordination polymer AX. On the other hand, the porous coordination polymer AX in the second ammonia adsorption unit 59 was placed in 100 mL of an aqueous sulfuric acid solution (pH 3), stirred at 25° C. for 1 hour, and then filtered using filter paper. The total nitrogen amount of the recovered filtrate (hereinafter, also referred to as “recovered liquid AL2”) was measured, and the ammonia amount was calculated to be 9.4 mg per 1 g of the porous coordination polymer AX.

As described above, it has been found that when water vapor and ammonia gas are mixed, a total of 22.2 mg of ammonia is adsorbed per 1 g of the porous coordination polymer AX.

TABLE 3

| | | Volume | TN | NH₃ | |
|---|---|---|---|---|---|
| | | (mL) | (mg/L) | (mg)/(1 g − AX) | |
| Experimental | Aqueous sulfuric acid solution recovered from first sulfuric acid | 200 | 148 | 36.1 | Total |
| Example 2-1 | scrubber (57) | | | | 48.2 |
| | Recovered liquid AL1 after porous coordination polymer AX in | 100 | 98 | 12.1 | |
| | first ammonia adsorption unit (56) was washed with aqueous | | | | |
| | sulfuric acid solution having pH of 3 | | | | |
| Experimental | Aqueous sulfuric acid solution recovered from second sulfuric | 200 | 54 | 12.8 | Total |
| Example 2-2 | acid scrubber (60) | | | | 22.2 |
| | Recovered liquid AL2 after porous coordination polymer AX in | 100 | 77 | 9.4 | |
| | second ammonia adsorption unit (59) was washed with aqueous | | | | |
| | sulfuric acid solution having pH of 3 | | | | |

It has been found from Table 3 that in Experimental Example 2-1 and Experimental Example 2-2, 48.2 mg and 22.2 mg of ammonia were contained per 1 g of the porous coordination polymer AX, respectively, and thus a mixed gas of ammonia and water was suitably used when ammonia gas was brought into contact with the porous coordination polymer.

Experimental Examples 2-1 and 2-2 are examples using the porous coordination polymer recovered after use in Experimental Example 1-1. It has been found that even if the recovered porous coordination polymer is reused, an adsorption function of ammonia gas can be sufficiently obtained.

In both Experimental Examples 2-1 and 2-2, a stream of dry air allowed ammonia to be easily desorbed and recovered from the porous coordination polymer to which ammonia had been adsorbed. In these experimental examples, there was ammonia remaining without being desorbed by the stream of dry air, which is considered to be a difference in adsorption mechanism such as adsorption to an active site or the like and adsorption derived from a wall surface potential. From the results of Experimental Examples 1-1 and 1-2, it is presumed that ammonia remained in the open metal site of the porous coordination polymer AX even after washing with an acidic liquid (aqueous sulfuric acid solution at a pH of 3) in Experimental Examples 2-1 and 2-2. Using the above results, if gases other than ammonia coexist as impurities, after ammonia and the impurities that can be easily desorbed by the stream of dry air are removed, the porous coordination polymer to which the residual ammonia has been adsorbed is recovered, and then ammonia is desorbed by heating or the like, whereby high-purity ammonia can be obtained. Therefore, when high-purity ammonia gas is recovered from a mixed gas containing ammonia and other gases, it is particularly useful to use a porous coordination polymer having an active site in obtaining high-purity ammonia by using a difference in adsorption mechanism.

### INDUSTRIAL APPLICABILITY

The method for recycling ammonia and the ammonia recycling apparatus from an ammonia-containing gas or an ammonia-containing liquid in the present invention can be applied to a semiconductor manufacturing plant, an ammonia manufacturing plant, a chemical material manufacturing plant using ammonia (a hydrogen manufacturing plant or the like), a chemical material manufacturing plant in which ammonia is by-produced, and the like. An exhaust gas or a waste liquid (RCA cleaning waste liquid, CMP waste liquid, BHF cleaning waste liquid, and the like) containing ammonia can be directly recovered from each site and subjected to the method for recycling ammonia, and therefore the ammonia recycling apparatus can be used. The recovered ammonia can be reused at the same site or the like.

The recovered ammonia can be used as a raw material of an original ammonia-containing chemical solution or the like. In this case, the recovered ammonia is suitable for effective use and circulation use of resources (collectively referred to as circular economy).

Further, the method for recycling ammonia and the ammonia recycling apparatus of the present invention can also be applied to a barn where an ammonia-containing gas is generated due to animal enteruria.

The ammonia gas storage apparatus of the present invention can be used in a semiconductor manufacturing plant, a chemical material manufacturing plant, a hydrogen manufacturing plant, and the like. The apparatus can also be used as an ammonia supply source in the case of using as an ammonia raw material of ammonia, a chemical, or the like, in the case of using as a fuel in a boiler, a fuel cell, or the like, or in the case of using as a refrigerant for cooling an article.

According to the ammonia gas storage apparatus of the present invention, appropriately adjusting moisture allows ammonia to be adsorbed and stored as ammonium ions on the porous coordination polymer, and allows the ratio of hydrogen atoms per ammonia to be increased, thus allowing suitable use as a hydrogen storage apparatus.

Further, when the ammonium ions are desorbed, forming a system in which ammonia molecules and hydrogen molecules generated by the desorption into a gas phase and a dissociation reaction, and ammonium ions coexist, and adsorbing and collecting ammonia with the porous coordination polymer control equilibrium to allow hydrogen to be obtained again, and thus the ammonia gas storage apparatus of the present invention can also be used as a hydrogen production apparatus using ammonia and the porous coordination polymer.

### REFERENCE SIGNS LIST

1: Ammonia recycling apparatus
2: Ammonia recycling apparatus
3: Ammonia recycling apparatus
4: Ammonia gas storage apparatus
5: Ammonia gas storage apparatus
11: Ammonia-containing gas storage unit
13: Ammonia adsorption unit
15: Ammonia desorption unit
17: Ammonia recovery unit
21: Water content adjusting unit
23: Other gas adsorption unit
31 to 35: Ammonia gas storage unit
37: Pressure control unit
39: Breakthrough detection unit
41 to 46: Ammonia gas storage unit
51: Air pump
52: First moisture absorption unit (calcium chloride)
53: Ammonia water storage unit
54: Second moisture absorption unit (sodium hydroxide+soda lime)
55: Air flow meter
56: First ammonia adsorption unit
57: First sulfuric acid scrubber
58: Air flow meter
59: Second ammonia adsorption unit
60: Second sulfuric acid scrubber

1. A method for recycling ammonia from an ammonia-containing gas, the method comprising,
bringing a gas containing ammonia into contact with a porous coordination polymer in which a metal ion and an organic ligand coordinately bonded to adsorb the ammonia to the porous coordination polymer, and
desorbing the ammonia from an ammonia-adsorbed porous coordination polymer to recover the ammonia, the ammonia-adsorbed porous coordination polymer being formed by adsorbing the ammonia to the porous coordination polymer.

2. The method for recycling ammonia from an ammonia-containing gas according to claim 1, wherein the porous coordination polymer has an internal pore with a pore diameter of 0.26 nm or more at time of adsorption of the ammonia.

3. The method for recycling ammonia from an ammonia-containing gas according to claim 1, wherein the porous coordination polymer has an active site.

4. The method for recycling ammonia from an ammonia-containing gas according to claim 1, wherein the metal ion constituting the porous coordination polymer comprises a metal selected from a group consisting of Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb, and Bi.

5. The method for recycling ammonia from an ammonia-containing gas according to claim 1, wherein the organic ligand constituting the porous coordination polymer is derived from carboxylic acids or azoles.

6. The method for recycling ammonia from an ammonia-containing gas according to claim 1, wherein the ammonia-containing gas is derived from a gas generated at a semiconductor manufacturing plant, an ammonia manufacturing plant, a chemical material manufacturing plant using ammonia, a chemical material manufacturing plant in which ammonia is by-produced, or a barn.

7. The method for recycling ammonia from an ammonia-containing gas according to claim 1, wherein the ammonia-containing gas is adjusted to contain 106 parts by mass or more of water when a content of the ammonia is set to 100 parts by mass.

8. The method for recycling ammonia from an ammonia-containing gas according to claim 1, wherein the porous coordination polymer is reused after the ammonia is desorbed from the ammonia-adsorbed porous coordination polymer.

9. An ammonia recycling apparatus used for the method for recycling ammonia from an ammonia-containing gas according to claim 1, the apparatus comprising:
an ammonia-containing gas storage unit configured to store a gas containing ammonia;
an ammonia adsorption unit configured to store a porous coordination polymer and bring the ammonia-containing gas supplied from the ammonia-containing gas storage unit into contact with the porous coordination polymer to adsorb the ammonia in the ammonia-containing gas to the porous coordination polymer;
an ammonia desorption unit configured to desorb the ammonia from the porous coordination polymer to which the ammonia is adsorbed, obtained in the ammonia adsorption unit; and
an ammonia recovery unit configured to recover the ammonia.

10. The ammonia recycling apparatus from an ammonia-containing gas according to claim 9, further comprising a water content adjusting unit configured to adjust a content ratio of water contained in the ammonia-containing gas so as to fall within a predetermined range based on a content of the ammonia, wherein the ammonia-containing gas contained in the ammonia-containing gas storage unit is derived from a gas generated at a semiconductor manufacturing plant, an ammonia manufacturing plant, a chemical material manufacturing plant using ammonia, a chemical material manufacturing plant in which ammonia is by-produced, or a barn.

11. A method for recycling ammonia from an ammonia-containing liquid, the method comprising,
bringing an ammonia-containing liquid containing ammonia into contact with a porous coordination polymer in which a metal ion and an organic ligand coordinately bonded to adsorb the ammonia to the porous coordination polymer, and
desorbing the ammonia from an ammonia-adsorbed porous coordination polymer to recover the ammonia, the ammonia-adsorbed porous coordination polymer being formed by adsorbing the ammonia to the porous coordination polymer.

12. The method for recycling ammonia from an ammonia-containing liquid according to claim 11, wherein a water-soluble organic solvent is adhered to the porous coordination polymer.

13. The method for recycling ammonia from an ammonia-containing liquid according to claim 11, wherein the porous coordination polymer has an active site.

14. The method for recycling ammonia from an ammonia-containing liquid according to claim 11, wherein the metal ion constituting the porous coordination polymer comprises a metal selected from a group consisting of Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb, and Bi.

15. The method for recycling ammonia from an ammonia-containing liquid according to claim 11, wherein the organic ligand constituting the porous coordination polymer is derived from carboxylic acids or azoles.

16. The method for recycling ammonia from an ammonia-containing liquid according to claim 11, wherein the ammonia-containing liquid is adjusted to be alkaline.

17. The method for recycling ammonia from an ammonia-containing liquid according to claim 16, wherein the ammonia contained in the alkaline ammonia-containing liquid is adsorbed to the porous coordination polymer, an acid is added to a mixed liquid of the alkaline ammonia-containing liquid and the porous coordination polymer to form an acidic liquid, the ammonia-adsorbed porous coordination polymer is recovered, and then the ammonia is desorbed from the ammonia-adsorbed porous coordination polymer.

18. The method for recycling ammonia from an ammonia-containing liquid according to claim 11, wherein the ammonia-containing liquid comprises a water-soluble organic solvent.

19. The method for recycling ammonia from an ammonia-containing liquid according to claim 11, wherein the ammonia-containing liquid is derived from a liquid generated at a semiconductor manufacturing plant, an ammonia manufacturing plant, a chemical material manufacturing plant using ammonia, or a chemical material manufacturing plant in which ammonia is by-produced, or a liquid containing ammonia discharged from a living organism.

20. The method for recycling ammonia from an ammonia-containing liquid according to claim 11, wherein the ammonia-containing liquid is a liquid subjected to ammonia stripping.

21. The method for recycling ammonia from an ammonia-containing liquid according to claim 11, wherein the porous coordination polymer is reused after the ammonia is desorbed from the ammonia-adsorbed porous coordination polymer.

22. An ammonia recycling apparatus used for the method for recycling ammonia from an ammonia-containing liquid according to claim 11, the apparatus comprising:
an ammonia-containing liquid storage unit configured to store an ammonia-containing liquid containing ammonia;
an ammonia adsorption unit configured to store a porous coordination polymer and bring the ammonia-containing liquid supplied from the ammonia-containing liquid storage unit into contact with the porous coordination polymer to adsorb the ammonia in the ammonia-containing liquid to the porous coordination polymer;
an ammonia desorption unit configured to desorb the ammonia from the porous coordination polymer to which the ammonia is adsorbed, obtained in the ammonia adsorption unit; and
an ammonia recovery unit configured to recover the ammonia.

23. An ammonia gas storage apparatus, the apparatus comprising:
an ammonia gas storage unit comprising a porous coordination polymer in which a metal ion and an organic ligand coordinately bonded, wherein an ammonia gas supplied from an outside is adsorbed to the porous coordination polymer and is held in an adsorbed state; and
a pressure control unit configured to adjust a pressure in the ammonia gas storage unit,
wherein the ammonia gas is stored by adjusting a supply amount of the ammonia gas to the ammonia gas storage unit and a pressure in the pressure control unit.
